(19) United States
(12) Patent Application Publication
(10) Pub. No.: US 2026/0043522 A1
(43) Pub. Date: Feb. 12, 2026

(54) CRYOGENIC FLUID STORAGE UNIT AND CORRESPONDING PRODUCTION METHOD

(71) Applicant: Faurecia Hydrogen Solutions France, NANTERRE (FR)

(72) Inventors: Frederic GREBER, ECOT (FR); Yannick FOURCAUDOT, LUZE (FR)

(21) Appl. No.: 19/291,921

(22) Filed: Aug. 6, 2025

(30) Foreign Application Priority Data
Aug. 7, 2024 (FR) 24 08758

(51) Int. Cl. F17C 13/00

(52) U.S. Cl. CPC F17C 13/002; F17C 2201/0109; F17C 2203/014; F17C 2203/03; F17C 2209/22; F17C 2221/012; F17C 2223/0161

(57) ABSTRACT

The storage unit comprises an internal reservoir, an external reservoir, and a suspension suspending the internal reservoir from the external reservoir; The
suspension comprises a link that includes
a cuff made of a composite material with a central axis,
a proximal link of a proximal axial end of the cuff to the internal reservoir; and
a distal link of a distal axial end of the cuff to the external reservoir. The
proximal link comprises
a body closing the proximal axial end of the cuff, the body having an external surface defining an external tapered bearing surface coaxial with the central axis and engaged inside the proximal axial end. The proximal link further comprises
a ring connected to the internal reservoir, the ring having an internal surface defining an internal tapered bearing surface coaxial with the central axis and surrounding the proximal axial end, the proximal axial end of the cuff is clamped between the external tapered bearing surface and the internal tapered bearing surface.

### CROSS-REFERENCE TO RELATED APPLICATION

This application is a U.S. non-provisional application claiming the benefit of French Application No. 24 08758, filed on Aug. 7, 2024, which is incorporated herein by reference in its entirety.

### TECHNICAL FIELD

The present disclosure relates in general to the storage of a cryogenic fluid.

### BACKGROUND

Such a cryogenic fluid storage unit typically comprises an internal reservoir inwardly delimiting a cryogenic fluid storage volume, an external reservoir wherein the internal reservoir is housed, and a suspension attaching the internal reservoir to the external reservoir.

The internal reservoir and the external reservoir delimit an intermediate space therebetween, kept under a high vacuum. Thermal insulation is preferably applied to the internal reservoir to limit heat exchange by radiation between the internal and external reservoirs. The vacuum in the intermediate space limits heat transfer by convection.

The suspension comprises a fixed link at one end of the internal reservoir, and a sliding link at the opposite end of this internal reservoir. It must support the internal reservoir in all circumstances. When the storage unit is carried on board a vehicle such as a truck, the suspension is particularly subject to stresses resulting from road conditions, truck acceleration or braking, or impact in the event of an accident. The suspension must remain operational for the entire service life of the reservoir, that is, 15 to 25 years.

In addition, the suspension must be as thermally insulating as possible, that is, transmit as little heat as possible from the external reservoir to the internal reservoir, particularly by conduction.

In this context, the disclosure aims to provide a solution that satisfies the above requirements.

### SUMMARY

To this end, according to a first aspect the disclosure relates to a cryogenic fluid storage unit comprising an internal reservoir inwardly delimiting a cryogenic fluid storage volume, an external reservoir wherein the internal reservoir is housed, and a suspension suspending the internal reservoir in the external reservoir;
the suspension comprising a link including:
   a cuff, made of a composite material, having a central axis;
   a proximal link of a proximal axial end of the cuff to the internal reservoir;
   a distal link of a distal axial end of the cuff to the external reservoir;
the proximal link comprising:
   a body closing the proximal axial end of the cuff, the body having an external surface defining an external tapered bearing surface coaxial with the central axis and engaged inside the proximal axial end, and
   a ring connected to the internal reservoir, the ring having an internal surface defining an internal tapered bearing surface coaxial with the central axis and surrounding the proximal axial end, the proximal axial end of the cuff being clamped between the external tapered bearing surface and the internal tapered bearing surface.

The use of a cuff made of a composite material drastically reduces conductive heat transfer from the external to the internal reservoir, compared with a suspension made of steel. In fact, composite materials have extremely low thermal conductivity. In particular, this thermal conductivity is much lower than the thermal conductivity of steel, which is commonly used to produce suspensions for cryogenic fluid storage units.

The cuff is attached to the internal reservoir via the tapered external bearing surface and the tapered internal bearing surface, which clamp the proximal axial end of the cuff therebetween.

This type of fastening ensures excellent attachment of the cuff to the internal reservoir. The force is distributed over the entire surface of the cuff's proximal axial end.

The cooperation of the two tapered bearing surfaces prevents them from being pulled loose under axial stress.

The use of a composite material for the cuff also makes the storage unit lighter, while providing excellent mechanical strength for the suspension.

The storage unit may further comprise one or more of the following features, considered alone or according to any technically possible combinations:
the proximal axial end of the cuff is tapered in shape;
at the proximal axial end of the cuff, the external tapered bearing surface and the internal tapered bearing surface have the same taper angle;
the external tapered bearing surface and the internal tapered bearing surface have a diameter that increases axially towards the inside of the internal container;
the external surface of the body defines an external cylindrical bearing surface offset towards the interior of the internal reservoir with respect to the external tapered bearing surface and coaxial with the central axis, the internal surface of the ring defining an internal cylindrical bearing surface offset towards the interior of the internal reservoir with respect to the internal tapered bearing surface and coaxial with the central axis, the external cylindrical bearing surface being engaged in the internal cylindrical bearing surface and rigidly fixed against the internal cylindrical bearing surface;
the cuff comprises a central section connecting the proximal axial end to the distal axial end, the distal axial end comprising a terminal section and a shoulder connecting the terminal section to the central section, the shoulder being recessed from the central section;
the distal link comprises an internal body of revolution housed inside the distal axial end and an external body of revolution surrounding the distal axial end and rigidly attached to the internal body of revolution, the shoulder being clamped axially between the internal body of revolution and the external body of revolution;
the link comprises an external tube surrounding the cuff, the ring of the proximal link being connected to the internal reservoir via the external tube;
a layer of thermal insulation is interposed between the external tube and the cuff;
at least one disc bearing thermal insulation is housed inside the cuff and seals off an internal section of the cuff.

According to a second aspect, the disclosure relates to a method for producing a storage unit having the features hereinbefore, the method comprising the following steps:
engaging the tapered external surface of the body axially inside the proximal axial end of the cuff, and
inserting the ring around the proximal axial end until the proximal axial end of the cuff is clamped between the external tapered bearing surface and the internal tapered bearing surface;
attaching the ring to the body.

### BRIEF DESCRIPTION OF THE DRAWINGS

Other features and advantages of the disclosure will become apparent from the detailed description given hereunder, by way of non-limiting indication, referring to the appended figures, among which:

FIG. 1 is an axial sectional view of a cryogenic fluid storage unit according to the disclosure, taken in a vertical plane containing the central axis of the internal reservoir;

FIG. 2 is an enlarged sectional view of one end of the storage unit, in a vertical plane containing the central axis of the internal reservoir, but viewed in a direction diametrically opposite to that of FIG. 1;

FIG. 3 is an enlarged view of the link linking the end of the internal reservoir to the end of the external reservoir in FIG. 2;

FIG. 4 is a simplified schematic representation of the weave used for the composite material forming the cuff of the link of FIG. 3; and

FIG. 5 shows part of the steps of the manufacturing process of the disclosure.

### DETAILED DESCRIPTION

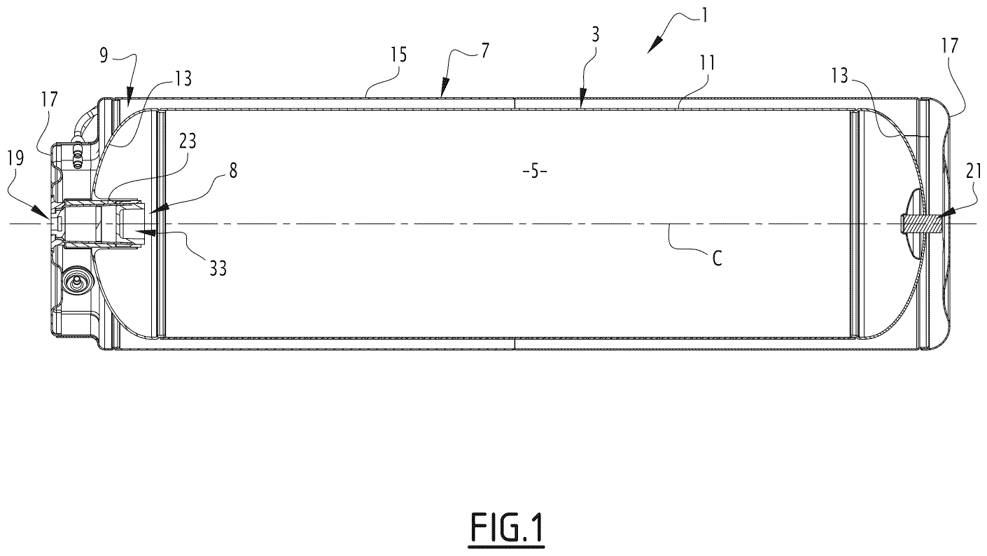

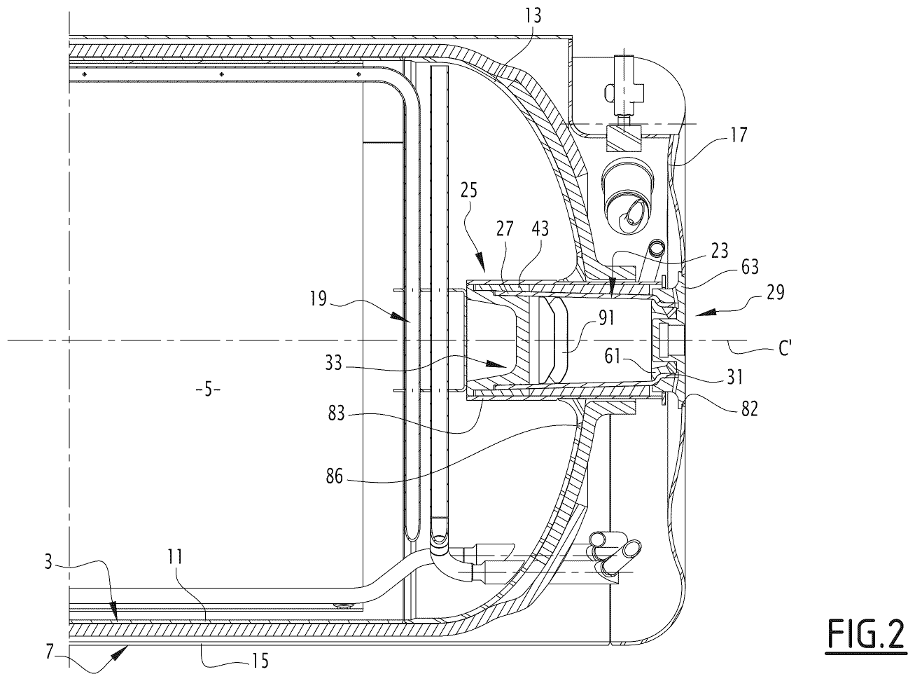

The cryogenic fluid storage unit 1 shown in FIGS. 1 and 2 is intended to store a cryogenic fluid. Cryogenic fluid is understood to mean a fluid at a very low temperature, which may be at least partially in the liquid state inside the storage unit 1.

This fluid is typically hydrogen, suitable for an internal combustion engine or fuel cell. Alternatively, the fluid is a natural gas such as methane CH₄, ammonia or any other fluid suitable for an internal combustion engine. In another variant, the fluid is a cryogenic fluid such as helium, nitrogen, or any other fluid suitable for industrial installations.

The storage unit 1 is typically intended to be installed on board a vehicle, for example a motor vehicle, a train, a boat or any other vehicle.

The motor vehicle is, for example, a car, a utility vehicle, a truck, etc.

The storage unit 1 is typically designed to supply an internal combustion engine equipping a motor vehicle.

Alternatively, the storage unit 1 is designed to supply a fuel cell. For example, the fuel cell is configured to produce electricity and to electrically supply an electric propulsion motor of the vehicle.

The cryogenic fluid storage unit 1 comprises an internal reservoir 3 inwardly delimiting a cryogenic fluid storage volume 5, an external reservoir 7 housing the internal reservoir 3, and a suspension 8 suspending the internal reservoir 3 to the external reservoir 7.

The internal reservoir 3 and the external reservoir 7 are separated from one another by an intermediate space 9 maintained at low pressure.

Typically, the intermediate space 9 is maintained under a high vacuum. This vacuum is typically of the order of 10⁻⁵ mbar, so as to strongly limit heat transfer by convection from the external reservoir 7 to the internal reservoir 3.

Thermal insulation (not shown) is interposed between the internal reservoir 3 and the external reservoir 7. The thermal insulation is typically placed on the external surface of the internal reservoir 3. It is, for example, of the MLI (Multi Layer Insulation) type and comprises a plurality of metal sheets superimposed on one another, with interposed layers of fibers.

The internal reservoir 3 has a central axis C. In the example shown, this axis is horizontal.

The internal reservoir 3 comprises a shell 11, closed at both opposite axial ends thereof by internal bottoms 13.

The shell 11 is cylindrical, centered on the central axis C.

The external reservoir 7 is coaxial with the internal reservoir 3.

It comprises a shell 15, closed at both opposite axial ends thereof by external bottoms 17.

The shell 15 is cylindrical, centered on the central axis C.

Suspension 8 typically comprises two links, a fixed link 19 and a sliding link 21. The disclosure relates to the fixed link 19.

The link 19 comprises, as shown in FIG. 2:
a cuff 23 made of a composite material, with a central axis C′;
a proximal link 25 of a proximal axial end 27 of the cuff 23 to the internal reservoir 3;
a distal link 29 of a distal axial end 31 of cuff 23 to external reservoir 7.

The central axis C′ of cuff 23 is typically aligned with the central axis C of the internal reservoir.

The proximal link 25 links the cuff 23 to an axial end of the internal reservoir 3.

In other words, proximal link 25 links the proximal axial end 27 of cuff 23 to one of the internal bottoms 13 of reservoir 3.

The distal link 29 links the cuff 23 to an axial end of the external reservoir 7.

In other words, it links the distal axial end 31 of cuff 23 to an external bottom 17 of external reservoir 7.

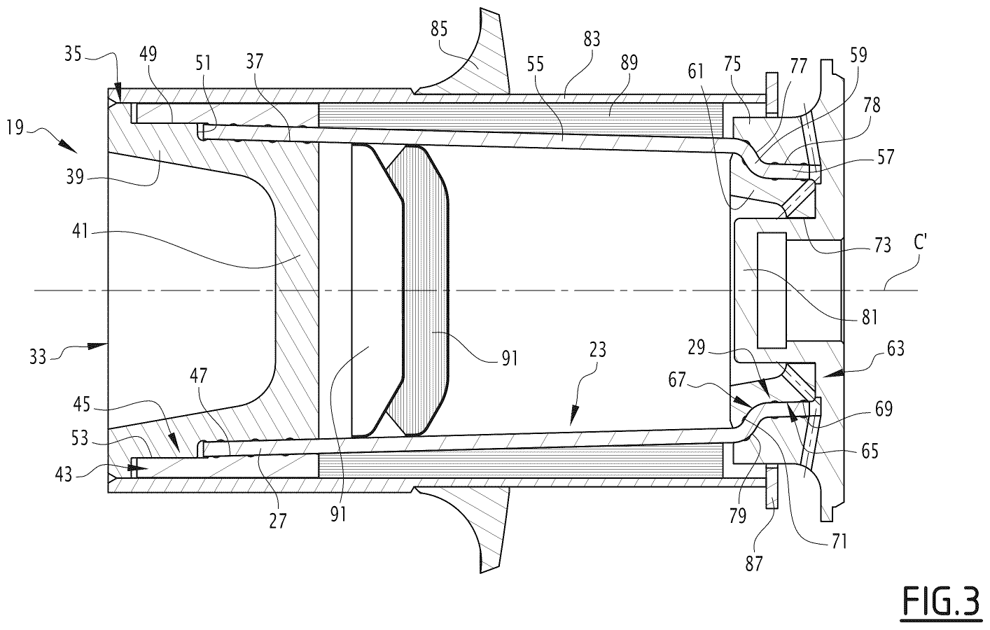

As shown in FIG. 3, the proximal link 25 comprises a body 33 closing the proximal axial end 27 of the cuff 23.

The body 33 is a part of revolution about the central axis C′.

The body 33 has an external surface 35 defining an external tapered bearing surface 37 coaxial with the central axis C′.

More precisely, the body 33 comprises a tubular wall 39 coaxial with the central axis C′, closed at one end by a bottom 41. The external surface 35 is defined by the wall 39. It faces radially outwards from tubular wall 39.

The external tapered bearing surface 37 is engaged inside the proximal axial end 27.

The proximal link 25 also includes a ring 43 linked to the internal reservoir 3. The ring 43 has an internal surface 45 delimiting an internal tapered bearing surface 47 coaxial with the central axis C′. The ring 43 surrounds the proximal axial end 27.

The ring 43 is generally tubular in shape. The internal surface 45 is the surface of the ring 43 facing radially towards the central axis C′.

As shown in FIG. 3, the proximal axial end 27 of cuff 23 is clamped between the external tapered bearing surface 37 and the internal tapered bearing surface 47. In other words, the proximal axial end 27 is tightly clamped between the external tapered bearing surface 37 and the internal tapered bearing surface 47.

The external tapered bearing surface 37 is in contact with a radially internal side of the proximal axial end 27, and the internal tapered bearing surface 47 is in contact with an external side of the proximal axial end 27.

Along the central axis C′, the external tapered bearing surface 37 and the internal tapered bearing surface 47 are substantially at the same level. They thus face each other radially.

The proximal axial end 27 of cuff 23 is tapered in shape.

The proximal axial end 27 of cuff 23, the external tapered bearing surface 37 and the internal tapered bearing surface 47 have the same taper angle.

In other words, all three are coaxial with the central axis C′, and each has a tapered shape with a circular base. They are generated by a generatrix having said taper angle with respect to the central axis C′.

The taper angle is typically between 1° and 15°, preferably between 2° and 10°, and for example 3°.

The external tapered bearing surface 37 and the internal tapered bearing surface 47 have a diameter that increases axially towards the inside of the internal reservoir 3.

The external surface 35 of the body 33 also defines an external cylindrical bearing surface 49 offset towards the interior of the internal reservoir 3 with respect to the external tapered bearing surface 37.

The external cylindrical bearing surface 49 is coaxial with the central axis C′. It adjoins the external tapered bearing surface 37. It is separated from the external tapered bearing surface 37 by a shoulder 51. This shoulder is substantially annular and centered on the central axis C′. It has a radial width substantially equal to the thickness of the proximal axial end 27 of cuff 23.

The diameter of the external cylindrical bearing surface 49 is thus greater than the diameter of the external tapered bearing surface 37.

In the same way, the internal surface 45 of the ring 43 defines an internal cylindrical bearing surface 53 offset towards the inside of the internal container 3 with respect to the internal tapered bearing surface 47.

The internal cylindrical bearing surface 53 is coaxial with the central axis C′. It adjoins the internal tapered bearing surface 47.

The diameter of the internal cylindrical bearing surface 53 is substantially equal to the largest diameter of the internal tapered bearing surface 47, that is, the diameter taken at the end forming the junction with the internal cylindrical bearing surface 53.

In other words, there is no break in level between the internal tapered bearing surface 47 and the internal cylindrical bearing surface 53.

The external cylindrical bearing surface 49 is engaged in the internal cylindrical bearing surface 53 and rigidly fixed against this internal cylindrical bearing surface 53.

The internal diameter of the internal cylindrical bearing surface 53 is substantially equal to the external diameter of the external cylindrical bearing surface 49.

The ring 43 and the body 33 are made of a metallic material. For example, they are made of steel.

In the example shown, the external cylindrical bearing surface 49 and the internal cylindrical bearing surface 53 are rigidly attached to one another by welding, preferably by laser welding to avoid overheating the link and damaging the cuff 23 made of composite material.

In addition to being clamped between the two tapered bearing surfaces, the proximal axial end 27 is also attached to the ring 43 and the body 33, preferably by adhesive bonding.

To this end, a glue-containing groove (not shown) is formed in the external tapered bearing surface 37.

Preferably, a further glue-containing groove is provided in the internal tapered bearing surface 47.

The glue contained in the groove(s) makes the attachment of the proximal axial end 27 to the internal reservoir 3 more resistant to being pulled loose along the central axis C′.

The cuff 23 also has a central section 55 connecting the proximal axial end 27 to the distal axial end 31.

The distal axial end 31 comprises a terminal section 57 and a shoulder 59 connecting the terminal section 57 to the central section 55.

The shoulder 59 is recessed from the central section 55.

In other words, the terminal section 57 has a smaller cross-section than the central section 55.

The distal link 29 has an internal body of revolution 61 housed inside the distal axial end 31. It also includes an external body of revolution 63 surrounding the distal axial end 31 and rigidly attached to the internal body of revolution 61.

The shoulder 59 is clamped axially between the internal body of revolution 61 and the external body of revolution 63.

The internal body of revolution 61 is typically a ring. It is of revolution about the central axis C′.

It has a radially outward external ring surface 65 having a shape corresponding to that of the radially internal surface 67 of the distal axial end 31. This external ring surface 65 is pressed against and bonded to the radially internal surface 67.

The external ring surface 65 has a substantially cylindrical or tapered surface 69 pressed against the terminal section 59, extended by a surface 71 steeply inclined relative to the central axis C′. This steeply inclined surface 71 is pressed against the shoulder 59.

The internal body of revolution 61 delimits a central orifice 73.

In the example shown, the external body of revolution 63 seals the distal axial end 31 of the cuff 23.

On its side facing axially towards the internal reservoir 3, the external body of revolution 63 carries a closed-contour crown 75 centered on the central axis C′.

The crown 75 is delimited radially towards the central axis C′ by an internal crown surface 77 having a shape corresponding to that of the radially external surface 78 of the distal axial end 31. This internal crown surface 77 is pressed against the radially external surface 78 and bonded to it.

The internal crown surface 77 has a substantially cylindrical or tapered surface pressed against the terminal section 59, on a radially external side of this section. This surface is extended by a surface 79 that is steeply inclined with respect to the central axis C′, pressed against the shoulder 59.

Shoulder 59 is pressed against surface 71 on one side and surface 79 on the other. As these surfaces are steeply inclined relative to the central axis C′, the distal axial end 31 of the cuff 23 is axially locked in position. The shoulder 59 ensures that the cuff 23 cannot be pulled loose when pulled along the central axis C′.

The external body of revolution 63 also features a central stud 81 engaged in the central hole 73. The external diameter of the central stud 81 corresponds to the internal diameter of the central orifice 73.

The external body of revolution 63 is rigidly attached to the external reservoir 7. It engages in a hole 82 in the external reservoir 7 (FIG. 2). Its peripheral edge is welded in a leak-tight manner to the edge of hole 82.

The bodies of revolution 61 and 63 are made of metal.

They are welded together, typically by a full-penetration weld. They are glued to the distal axial end 31.

Link 19 also includes an external tube 83 surrounding cuff 23.

The ring 43 of the proximal link is connected to the internal reservoir via the external tube 83.

To do this, the ring 43 is engaged inside the external tube 83 and rigidly attached to it.

The external tube 83 is made of metal. The ring 43 is typically welded to the external tube 83.

The external tube 83 carries on its external surface a crown 85 for attachment to the internal reservoir. The crown 85 is rigidly attached to the external tube 83. It engages in a hole 86 in the internal reservoir 3 (FIG. 2). Its peripheral edge is welded in a leak-tight manner to the edge of hole 86.

The external tube 83 is coaxial with the central axis C′. It extends axially from the ring 43 to the external body of revolution 63. At its end opposite ring 43, it carries a washer 87 forming a movement limiter.

The washer 87 surrounds the crown 75, with reduced clearance between the crown 75 and the internal edge of the washer 87. The washer 87 cooperates with the external body of revolution 63 to limit the radial displacement of the cuff 23. If the cuff 23 breaks, the internal reservoir 3 is no longer attached to the external reservoir 7. The washer 87 limits movement between the two reservoirs 3, 7. As a result, the probability of rupture of the tubes coming from inside the internal reservoir 3 and passing through the external reservoir 7 is low.

A layer of thermal insulation 89 is interposed between the cuff 23 and the external tube 83. This thermal insulation layer 89 fills substantially all the space radially between cuff 23 and external tube 83, and axially between ring 43 and external body of revolution 63.

The thermal insulation layer 89 is of the same type as that insulating the internal reservoir 3 from the external reservoir 7. In other words, it's a thermal insulation layer of the MLI (Multi Layer Insulation) type. It comprises a plurality of metal sheets superimposed on one another, with interposition of fiber layers.

Such a structure is well known and will not be described in detail here.

The thermal insulation layer 89 greatly limits radiation between the cuff 23 and the external tube 83.

In addition, as shown in FIG. 3, at least one disc 91 having thermal insulation is housed inside cuff 23 and seals off an internal section of cuff 23.

Typically, several discs 91 are arranged one behind the other, each disc 91 sealing off an internal section of the cuff 23.

Each disk 91 carries thermal insulation of the same type as the layer 89, that is, MLI-type thermal insulation.

Each disc 91 seals off a straight section of the internal volume of cuff 23. The cross-section considered here is a cross-section taken perpendicular to the central axis C′, and delimited by the internal surface of cuff 23. Each disc 91 has a radially external edge of the same shape as the internal surface of cuff 23 in said section.

The insulation provided by the discs 91 limits thermal radiation inside the cuff 23, in particular the thermal radiation emitted by the bodies of revolution 61 and 63 towards the body 33 and towards the internal surface of the cuff 23.

Advantageously, cuff 23 has a generally tapered shape.

The central section 55 thus forms an extension of the proximal axial end 27. It is itself tapered, coaxial with the central axis C′, with the same taper angle as the proximal axial end 27.

Cuff 23 is made of a composite material comprising, in a conventional manner, fibers embedded in a resin matrix.

The fibers are advantageously selected from the following list: E-glass fibers, ECR-glass fibers, S-glass fibers, silica fibers, aramid fibers, especially Kevlar, or carbon fibers.

Preferably, the fibers are E-glass fibers for reasons of cost and performance.

The fibers are intertwined to form a three-dimensional weave.

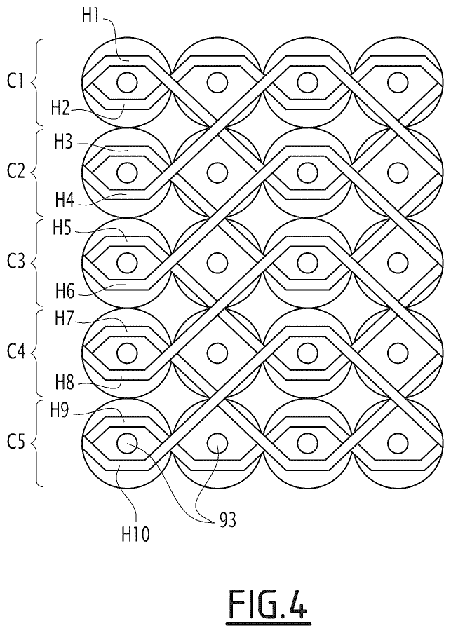

Thus, the composite material comprises a plurality of axial fibers, referenced 93 in FIG. 4, distributed in several superimposed layers.

For example, axial fibers 93 are divided into five superimposed layers.

Axial fibers 93 extend along generatrices of cuff 23. They are evenly distributed circumferentially around the central axis C′.

The composite material also comprises fibers H1 to H10 arranged helically around the central axis C′. The helical fibers H1 to H10 are arranged in such a way as to join the layers together.

Each helical fiber has a helix angle of between 30° and 70°, preferably 45° for example. Half of the fibers wrap circumferentially in one direction of rotation about the central axis C′, and another half of the fibers wrap circumferentially in the opposite direction of rotation about the central axis C′.

The organization of helical fibers H1 to H10 is shown schematically in FIG. 4. This figure shows the five layers C1 to C5 superimposed on one another. Axial fibers 93 are represented by dots.

Ten helical fibers H1 to H10 are shown schematically in FIG. 4. Helical fiber H1 is entangled with axial fibers 93 of layers C1 and C2. Helical fiber H2 is entangled only with the axial fibers 93 of the layer C1. Helical fiber H3 is entangled with axial fibers 93 of layers C2 and C3. Helical fiber H4 is entangled with axial fibers 93 of layers C2 and C3. Helical fiber H5 is entangled with axial fibers 93 of layers C3 and C4. Helical fiber H6 is entangled with axial fibers 93 of layers C2 and C3. Helical fiber H7 is entangled with axial fibers 93 of layers C4 and C5. Helical fiber H8 is entangled with axial fibers 93 of layers C3 and C4. Helical fiber H9 is entangled only with axial fibers 93 of layer C5. Helical fiber H10 is entangled with axial fibers 93 of layers C4 and C5.

This ensures a strong bond between all the layers of composite material over the entire surface of cuff 23.

This arrangement also has the advantage that the cuff 23 has exactly the required thickness over its entire surface, and poses no problems of delamination between the layers or of relative positioning between the different layers.

In an exemplary embodiment for a cryogenic hydrogen storage unit with a capacity of 750 liters, the length of cuff 23 is approximately 150 mm. The composite material has a conductivity of 0.1 W/m·K at 20K and 0.6 W/m·K at 20° C. The total thermal input of the cuff is approx. 0.5 W. The largest diameter of cuff 23 is approximately 78 mm. The thickness of cuff 23 varies from 5 mm at its smallest diameter to 4.5 mm at its largest diameter.

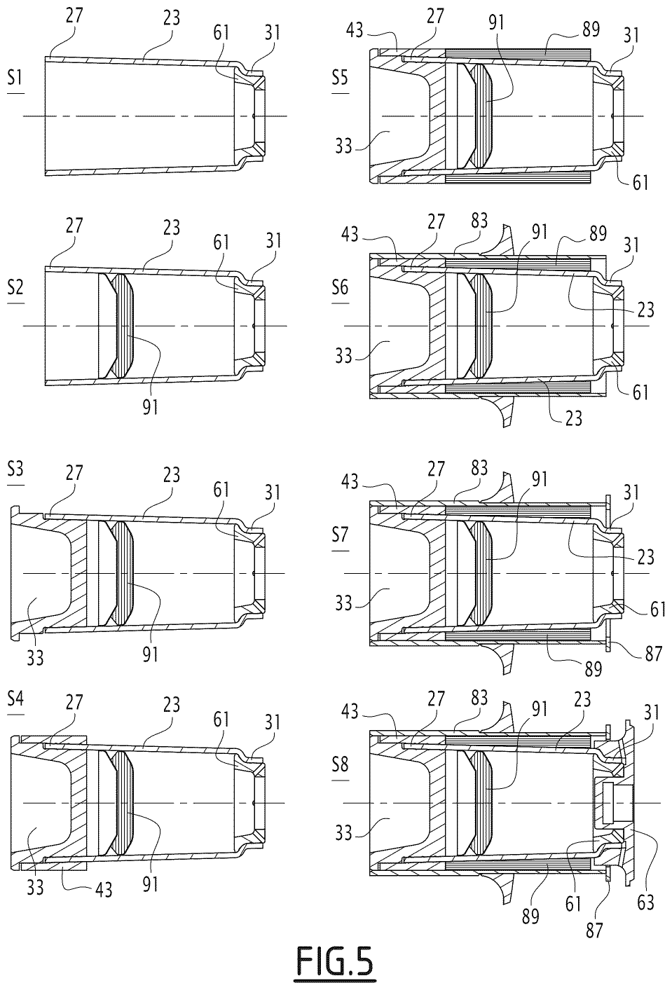

The manufacturing method for storage unit 1 will now be described, with reference to FIG. 5.

The manufacturing method includes a first step S1 of obtaining the cuff 23, and of engaging the internal body of revolution 61 in the cuff 23.

Due to the generally tapered shape of cuff 23, the internal body of revolution 61 is inserted into cuff 23 via the proximal axial end 27. It is moved axially to the distal axial end 31 and bonded to the distal axial end 31.

In step S2, the or each thermal insulation disc 91 is positioned inside the cuff 23. The thermal insulation discs 91 are inserted through the proximal axial end 27 and moved axially to their final position.

In step S3, the external tapered bearing surface 37 of body 33 is axially engaged inside the proximal axial end 27 of cuff 23.

It is engaged until the proximal axial end 27 is in contact with the external tapered bearing surface 37. It is preferably bonded to the proximal axial end 27.

In step S4, the ring 43 is inserted around the proximal axial end 27 until the proximal axial end 27 of the cuff 23 is clamped between the external tapered bearing surface 37 and the internal tapered bearing surface 47.

The ring 43 is first engaged around the distal axial end 31 of the cuff 23, then moved axially towards the proximal axial end 27. It is oriented with the internal cylindrical bearing surface 53 facing the body 33.

The ring 43 is moved axially until the proximal axial end 27 of the cuff 23 is sufficiently pressed between the two tapered bearing surfaces 37, 47. At this point, the internal cylindrical bearing surface 53 and the external cylindrical bearing surface 49 are facing one another and in contact with one another.

The two cylindrical bearing surfaces 49, 53 are then welded together.

In step S5, the insulating layer 89 is placed around the cuff 23.

In step S6, the external tube 83, carrying the crown 85, is positioned around the insulating layer 89 and welded to the ring 43.

In step S7, the washer 87 is attached to the end of the external tube 83.

Finally, in step S8, the external body of revolution 63 is engaged around the distal axial end 31 and bonded to this axial end. The internal body of revolution 61 and the external body of revolution 63 are then welded together.

In a step not shown in FIG. 5, the subassembly obtained in step S8 is attached to the internal reservoir 3. To do this, the peripheral edge of the crown 85 is welded to the corresponding hole 86 of the internal reservoir 3.

Once the internal reservoir 3 has been inserted into the external reservoir 7, the external body of revolution 63 is rigidly attached to the external reservoir 7. To do this, the peripheral edge of the external body of revolution 63 is welded into the corresponding hole 82 of the external reservoir 7.

1. A cryogenic fluid storage unit, comprising an internal reservoir inwardly delimiting a cryogenic fluid storage volume, an external reservoir housing the internal reservoir, and a suspension suspending the internal reservoir in the external reservoir;
the suspension comprising a link including:
a cuff made of a composite material with a central axis;
a proximal link of a proximal axial end of the cuff to the internal reservoir;
a distal link of a distal axial end of the cuff to the external reservoir;
the proximal link comprising:
a body closing the proximal axial end of the cuff, the body having an external surface defining an external tapered bearing surface coaxial with the central axis and engaged inside the proximal axial end, and
a ring connected to the internal reservoir, the ring having an internal surface defining an internal tapered bearing surface coaxial with the central axis and surrounding the proximal axial end, the proximal axial end of the cuff being clamped between the external tapered bearing surface and the internal tapered bearing surface.

2. The cryogenic fluid storage unit according to claim 1, wherein the proximal axial end of the cuff has a tapered shape.

3. The cryogenic fluid storage unit according to claim 2, wherein the proximal axial end of the cuff, the external tapered bearing surface and the internal tapered bearing surface have the same taper angle.

4. The cryogenic fluid storage unit according to claim 1, wherein the external tapered bearing surface and the internal tapered bearing surface have a diameter which increases axially towards an interior of the internal reservoir.

5. The cryogenic fluid storage unit according to claim 1, wherein the external surface of the body defines an external cylindrical bearing surface offset towards an interior of the internal reservoir with respect to the external tapered bearing surface and coaxial with the central axis, the internal surface of the ring defining an internal cylindrical bearing surface offset towards the interior of the internal reservoir with respect to the internal tapered bearing surface and coaxial with the central axis, the external cylindrical bearing surface being engaged in the internal cylindrical bearing surface and rigidly attached against the internal cylindrical bearing surface.

6. The cryogenic fluid storage unit according to claim 1, wherein the cuff comprises a central section connecting the proximal axial end to the distal axial end, the distal axial end comprising an end section and a shoulder connecting a terminal section to the central section, the shoulder being recessed from the central section.

7. The cryogenic fluid storage unit according to claim 6, wherein the distal link comprises an internal body of revolution housed inside the distal axial end and an external body of revolution surrounding the distal axial end and rigidly attached to the internal body of revolution, the shoulder being clamped axially between the internal body of revolution and the external body of revolution.

8. The cryogenic fluid storage unit according to claim 1, wherein the link comprises an external tube surrounding the cuff, the ring of the proximal link being connected to the internal reservoir via the external tube.

9. The cryogenic fluid storage unit according to claim 8, wherein a thermal insulation layer is interposed between the external tube and the cuff.

10. The cryogenic fluid storage unit according to claim 1, wherein at least one disc carrying thermal insulation is housed inside the cuff and seals off an internal section of the cuff.

11. A method for producing a storage unit according to claim 1, the method comprising the following steps:
engaging the external tapered bearing surface of the body axially inside the proximal axial end of the cuff, and
inserting the ring around the proximal axial end, until the proximal axial end of the cuff is clamped between the external tapered bearing surface and the internal tapered bearing surface;
attaching the ring to the body.
